(19) United States
(12) Patent Application Publication
(10) Pub. No.: US 2019/0145719 A1
(43) Pub. Date: May 16, 2019

(54) EXCHANGER FRAME AND CORE ASSEMBLY OF A MOTOR VEHICLE AND METHODS OF USE THEREOF

(71) Applicant: Valeo North America, Inc., Troy, MI (US)

(72) Inventor: Issmail Meskin, Troy, MI (US)

(73) Assignee: Valeo North America, Inc., Troy, MI (US)

(21) Appl. No.: 15/812,167

(22) Filed: Nov. 14, 2017

(51) Int. Cl. F28F 9/00; B60K 11/04

(52) U.S. Cl. CPC F28F 9/002; F28F 2265/30; B60K 11/04

(57) ABSTRACT

An exchanger assembly with a heat exchanger that includes a core and at least one tank assembled to the core. Additionally, exchanger assembly includes a structural frame to allow the heat exchanger to be removably encapsulated within the structural frame and a plurality of dampers and/or isolators affixed to the structural frame. Furthermore, the plurality of dampers and/or isolators facilitate mounting of the structural frame to a motor vehicle front end assembly.

### BACKGROUND

A heat exchanger is a device used to transfer heat between a solid object and a fluid, or between two or more fluids. The fluids may be separated by a solid wall to prevent mixing or they may be in direct contact. Heat exchangers are widely used in space heating, refrigeration, air conditioning, power stations, chemical plants, petrochemical plants, petroleum refineries, natural-gas processing, and sewage treatment. The classic example of a heat exchanger is found in an internal combustion engine in which a circulating fluid known as engine coolant flows through radiator coils and air flows past the coils, which cools the coolant and heats the incoming air. Another example is the heat sink, which is a passive heat exchanger that transfers the heat generated by an electronic or a mechanical device to a fluid medium, often air or a liquid coolant.

As discussed above, radiators are heat exchangers used to transfer thermal energy from one medium to another for the purpose of cooling and heating. The majority of radiators are constructed to function in automobiles, buildings, and electronics. The radiator is always a source of heat to its environment, although this may be for either the purpose of heating this environment, or for cooling the fluid or coolant supplied to it, as for engine cooling. Radiators are used for cooling internal combustion engines, mainly in automobiles but also in piston-engine aircraft, railway locomotives, motorcycles, stationary generating plants and other places where such engines are used.

To cool down the engine, a coolant is passed through the engine block, where it absorbs heat from the engine. The hot coolant is then fed into the inlet tank of the radiator (located either on the top of the radiator, or along one side), from which it is distributed across the radiator core through tubes to another tank on the opposite end of the radiator. As the coolant passes through the radiator tubes on its way to the opposite tank, it transfers much of its heat to the tubes which, in turn, transfer the heat to the fins that are lodged between each row of tubes. The fins then release the heat to the ambient air. Fins are used to greatly increase the contact surface of the tubes to the air, thus increasing the exchange efficiency. The cooled coolant is fed back to the engine, and the cycle repeats.

### SUMMARY OF DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, the embodiments disclosed herein relate to an exchanger assembly which may include a heat exchanger, the heat exchanger comprises a core and at least one tank assembled to the core; a structural frame, wherein the heat exchanger is removably encapsulated within the structural frame; and a plurality of dampers and/or isolators affixed to the structural frame, wherein the plurality of dampers and/or isolators facilitate mounting of the structural frame to a motor vehicle front end assembly.

In one aspect, the embodiments disclosed herein relate to a method for installing an exchanger assembly to a motor vehicle which may include inserting a heat exchanger into a structural frame, wherein the heat exchanger comprises a core and at least one tank assembled to the core, wherein, upon insertion, the core and at least one tank are encapsulate within the structural frame; affixing a plurality of dampers and/or isolators to the structural frame; and connecting the structural frame to a front end assembly of the motor vehicle using the plurality of dampers and/or isolators.

In one aspect, the embodiments disclosed herein relate to a method for manufacturing an exchanger assembly which may include assembling a heat exchanger including a core and at least one tank by affixing the at least one tank on a lateral side of the core; building a structural frame to encapsulate the heat exchanger, wherein the structural frame is built with an opening and includes at least one interfacing part configured to isolate the at least one tank of the heat exchanger; inserting the heat exchanger into the opening of the structural frame thereby completely encompassing the core and the at least one tank within the structural frame; and affixing a plurality of dampers and/or isolators to the structural frame.

Other aspects and advantages will be apparent from the following description and the appended claims.

### BRIEF DESCRIPTION OF DRAWINGS

FIG. 1 illustrates a schematic view of an exchanger frame and core assembly according to one or more embodiments of the present disclosure.

FIG. 2 illustrates a schematic view of an exchanger frame and core assembly of FIG. 1 according to one or more embodiments of the present disclosure.

FIG. 3 illustrates a system in which an exchanger frame and core assembly of FIG. 1 is used in according to one or more embodiments of the present disclosure.

FIG. 4 illustrates a block diagram of using an exchanger frame and core assembly according to one or more embodiments of the present disclosure.

### DETAILED DESCRIPTION

Embodiments of the present disclosure are described below in detail with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Those skilled in the art would appreciate how the term motor vehicle hereinafter may be understood to be a truck, a car, sport utility vehicle or suburban utility vehicle (SUV), or any known automobile in the art. As used herein, the term “coupled” or “coupled to” or “connected” or “connected to” may indicate establishing either a direct or indirect connection, and is not limited to either unless expressly referenced as such. Wherever possible, like or identical reference numerals are used in the figures to identify common or the same elements. The figures are not necessarily to scale and certain features and certain views of the figures may be shown exaggerated in scale for purposes of clarification.

Embodiments of the invention relate to a heat exchanger with a core composed with a non-structural or semi-structural tanks that is encapsulated in a structural frame. In one or more embodiments the structural frame will hold the heat exchanger and enable to guarantee the integrity of the heat exchanger under the environment loads and stresses. Additionally, the structural frame will aid in providing the insulation characteristics to isolate a cooling module pack from a front end module structure of the motor vehicle. Furthermore, the use of the structural frame does not require the need to pins on the heat exchanger.

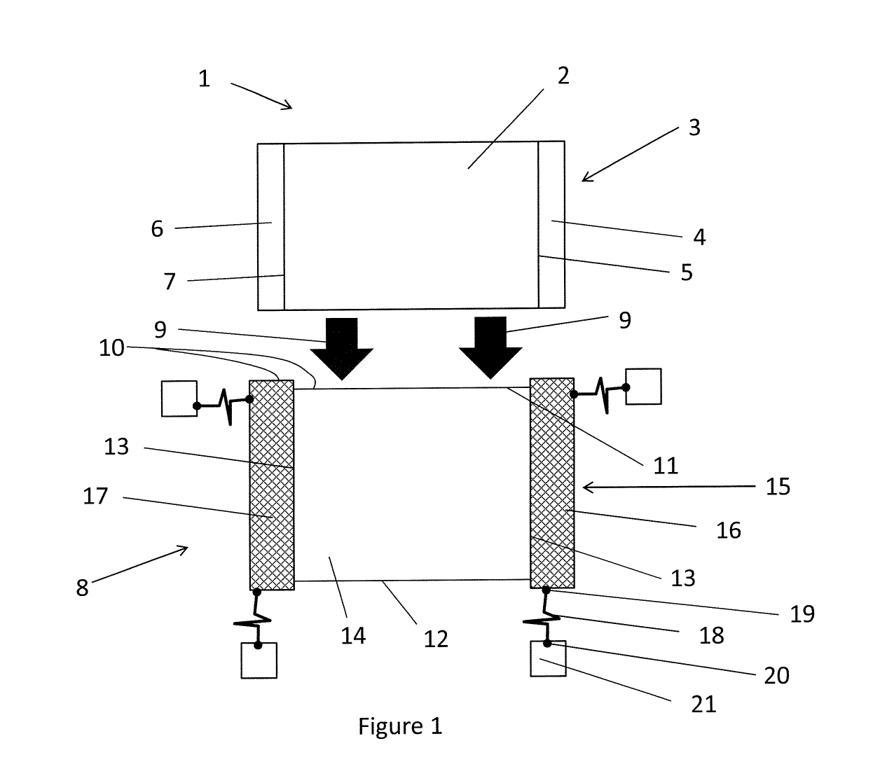

Turning to FIG. 1, in one or more embodiments, FIG. 1 illustrates a heat exchanger 1 for a motor vehicle (not shown). The heat exchanger 1 may be a radiator or any heat exchangers known in the art. The heat exchanger 1 includes a core 2 with at least one tank 3 assembled to the core 2. In one or more embodiments, the heat exchanger 1 may have a first tank 4 assembled on a first lateral side 5 of the core 2. Additionally, a second tank 6 may be assembled on a second lateral side 7 of the core 2. As seen by FIG. 1, the first and second tanks 4, 6 are opposite each other on adjacent lateral sides 5, 7 of the core 2. Heat exchangers are well known in the art, and thus, a simply overview of the heat exchanger's 1 internal components are provided, as they are not shown. A tube bundle (not shown) is within The core 2 of the heat exchanger 1 and the tube bundle includes at least one set of tubes. The tubes may be any type of tubes know in the art. The purpose of the tubes is for one set of these tubes to contain a first fluid (not shown) that must be either heated or cooled. The first fluid enters an inlet (not shown) of the at least one tank 3, and then from the at least one tank 3, the first fluid flows into one set of tubes in the core 2. Once the first fluid is in one set of tubes, the first fluid travel thru the core 2 and will exit the core 2 into the at least one tank 3, which has an (outlet) for the first fluid to exit the heat exchanger 1. Additionally, a second (not shown) fluid runs over the tubes that are being heated or cooled so that it can either provide the heat or absorb the heat required based on what is needed. The second fluid flows over the tubes in the core by entering an inlet and outlet (not shown) of the core not in fluid communication with the tubes. In addition to the above mentioned tanks, in one or more embodiments, the at least one tank 3 may act as a liquid/gas phase-shifter, a filter and storage unit for the first fluid. Additionally, one of ordinary skill would appreciate how the heat exchanger 1 is assembled by affixing the at least one tank 3 to any side of the core 2.

Still referring to FIG. 1, in one or more embodiments, a structural frame 8 to removably encapsulate the heat exchanger 1 is illustrated. The heat exchanger 1 is inserted into the structural frame 8 as seen by arrows 9. The arrows 9 illustrate the heat exchanger 1 being inserted into an opening 10 of the structural frame 8. It is further envisioned that while FIG. 1 shows the opening 10 in a top of the structural frame 8, the opening may be on any side of the structural frame 8. In some embodiments, the structural frame 8 may be modular (i.e., multiple parts) and placed (i.e., assembled) on the heat exchanger 1 to removably encapsulate the heat exchanger 1. Furthermore, the opening 10 may include a mechanical fastener (i.e., a latch or door) to open and closed the opening 10. In one or more embodiments, the structural frame may include a top beam 11, bottom beam 12, and two side beams 13 to create an inner frame. The inner frame acts as a core portion 14 to encapsulated the core 2 of the heat exchanger and may also encapsulate the at least one tank 3. Additionally, the structural frame 8 includes at least one interfacing part 15. The at least one interfacing part 15 isolates the at least one tank 3 of the heat exchanger 1. In one or more embodiments, the structural frame 8 includes a first tank portion 16 and a second tank portion 17 (i.e., the at least one interfacing part 15) to encapsulated the first tank 4 and second tank 6 of the heat exchanger 1, respectively. One skilled in the art will appreciate how the at least one interfacing part 15 is made to have a pattern (as seen by the hash-marks), and thus, easily distinguish the structural frame 8 from the motor vehicle (not shown). Furthermore, the structural frame 8 may be built to be a skeleton-type frame to be around the outer surface of the heat exchanger 1 or a tank to completely enclose the heat exchanger 1. It is further envisioned that the structural frame 8 may be fitted with apertures (not shown) which corresponded with the respective inlets and outlets of the heat exchanger 1. Additionally, when building the structural frame 8, the material used to make the structural frame 8 may be a composite material, thermal plastic material, carbon fiber material, glass material, structural foam, sandwich material, a metal material, or any combination thereof. It is further envisioned that the material used may additionally aid the structural frame 8 to absorb all the forces, pressures, and stresses that are supported by the heat exchanger 1. Furthermore, the structural frame 8 is created through the various manufacturing process of the aforementioned materials (i.e., casing, molding, forging, welding, machining, etc.). Additionally, insulation material or coatings may be added to the structural frame 8.

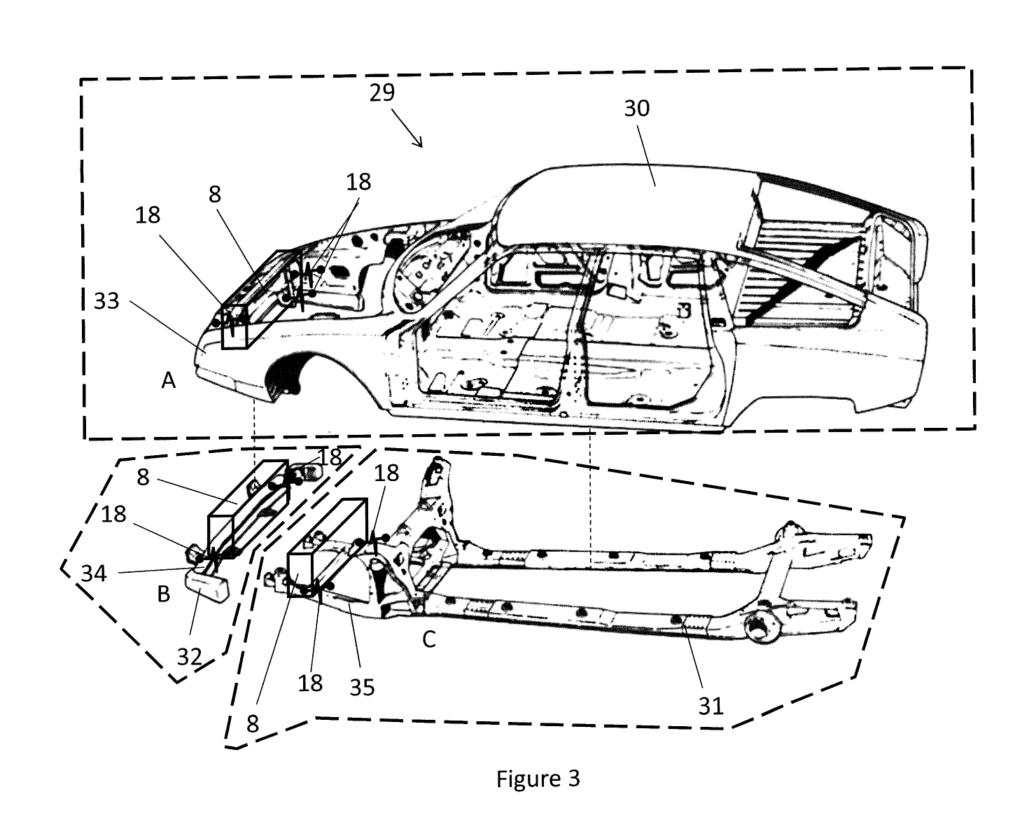

In one or more embodiments, the structural frame 8 includes a plurality of dampers and/or isolators 18 affixed to the structural frame 8. While FIG. 1 shows four dampers and/or isolators 18, the present invention, in one or more embodiments, is not limited to 4 and may have as many or little dampers and/or isolators needed for secure mounting. The plurality of dampers and/or isolators 18 may be made of a silicone material, a rubber material, a metallic material, a plastic material, or a combination thereof. Additionally, one skilled in the art will appreciate how the plurality of dampers and/or isolators 18 function as an anti-vibration device to decrease damage and stresses that may occur to the structural frame 8 and heat exchanger 1. It is further in envisioned that the plurality of dampers and/or isolators 18 may be integrated into the structural frame 8 to be one piece. As seen by FIG. 1, the plurality of dampers and/or isolators 18 are affixed to the at least one interfacing part 15 of the structural frame 8; however, the plurality of dampers and/or isolators 18 are not limited to only being affixed the at least one interfacing part 15 the structural frame 8. Further seen by FIG. 1, in one or more embodiments, the plurality of dampers and/or isolators 18 has a first end 19 connected to the at least one interfacing part 15 and a second end 20 connected to a mounting device 21. As seen by FIG. 1, the mounting device 21 is represented by a box for simplicity purposes. The mounting device 21 may be any known device which allows for the plurality of dampers and/or isolators 18 to be affixed to (see FIG. 3). For example, the mounting device may be a motor vehicle front end assembly, a bolster of the motor vehicle, an active grille shutter attached to the bolster, vehicle rails, or a frame of the motor vehicle, as will be described in FIG. 3.

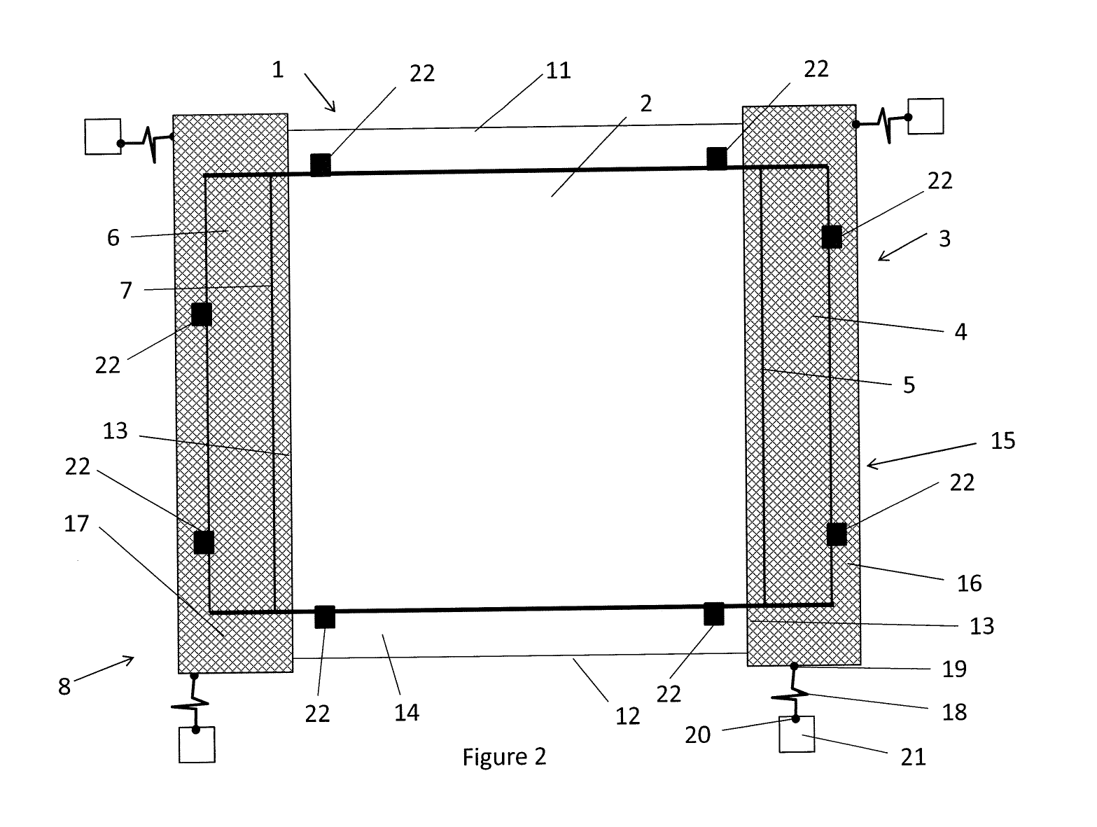

Now referring to FIG. 2, the heat exchanger 1 is removably encapsulated within the structural frame 8 according to one or more embodiments is shown. By having the heat exchanger 1 within the structural frame 8, the heat exchanger 1 may be insulted and protected from outside stress and load experienced on the motor vehicle. For example, wind forces, vibrations, motor vehicle accidents, and/or weather conditions (i.e., excess heat, cold, rain, hail, etc. . . . ) may be mitigated from the heat exchanger 1 by the structural frame 8. In the case of a motor vehicle accident, the structural frame 8 may be fixed with a pressure sensor (not shown), when the pressure reaches a threshold limit, the structure frame 8 may move and/or disengage from the motor vehicle to avoid damage to the heat exchanger 1. For example, the pressure sensor sends a signal to a release mechanism (not shown) to move and/or disengage the structure frame 8 automatically or manually. It is further envisioned that the release mechanism may be a quick release lever/button to allow for easy movement/release of the structure frame 8 to avoid damage, for repairs, or for removal of the structure frame 8. In some embodiments, the structure frame 8 may include a drain (not shown) to divert external water from entering the heat exchanger 1. For example, when a motor vehicle is traveling on a surface that has water (i.e., flooding), the drain will divert the water so that the heat exchanger 1 within the structure frame 8 does not flood.

Further seen by FIG. 2, in one or more embodiments, the core 2 of the heat exchanger is encapsulated within the core portion 14 of the structural frame 8. Once the core 2 is within the core portions 14, a plurality of mechanical fasteners or inserts 22, such as screws or adhesives, may be used to hold the core 2 in place within the structural frame 8. Similarly, when first tank 4 and the second tank 6 are isolated by the first tank portion 16 and the second tank portion 17, respectively, the plurality of mechanical fasteners or inserts 22 may also be used to secure the two tanks 4, 6 within the structural frame 8. It is further envisioned that the plurality of mechanical fasteners or inserts 22 maybe be placed anywhere within the structural frame 8 to suit the heat exchanger 1. The plurality of mechanical fasteners or inserts 22 is not limited to a specific number (as eight are shown in FIG. 2) and may include as many or as little needed to secure the heat exchanger 1. In one or more embodiments, the structural frame 8 may be built to with internal groves to hold the heat exchanger 1 in place. Additionally, the structural frame 8 may be built to fit perfectly over the heat exchanger 1 to allow no movement of heat exchanger 1 within the structural frame 8. It is further envisioned that the core 2 and the tank assembly (the first tank 4 and the second tank 6) may be pre-secured within the structural frame 8 using snaps and mechanical guides. For example, the snaps set the core 2 and the tank assembly in position within the structural frame 8 to allow for easy fastening to the structural frame 8. One skilled in the art will appreciate how the above methods for holding the heat exchanger 1 within the structural frame 8 may be used in conjunction or alone.

Now referring to FIG. 3, in one or more embodiments, FIG. 3 illustrates an exploded view of a motor vehicle 29 having a body 30, a frame 31, and a front bumper 32 (i.e., the mounting devices 21 in FIGS. 1 and 2). One of ordinary skill in the art will understand that the motor vehicle 29 is in the exploded view to show the structural frame 8 installed on multiple locations of the motor vehicle 29 that otherwise could not be shown as the body 30 of the motor vehicle 29 would impend a line of sight of the structural frame 8. Additionally, the structural frame 8 with the heat exchanger 1 encapsulated is shown as a transparent box for simplicity purposes only and one of ordinary skill in the art would understand the structural frame 8 with the heat exchanger 1 is as described in FIGS. 1 and 2 above. FIG. 3 shows three examples of affixing the structural frame to various parts of the vehicle. As shown by the label “A” in FIG. 3, the plurality of dampers and/or isolators 18 have the first end affixed to the structural frame 8 and the second end to a front end 33 of the body 30. Further, in scenario B, the plurality of dampers and/or isolators 18 have the first end affixed to the structural frame 8 and the second end to an inner surface 34 of the bumper 32. In scenario C, the plurality of dampers and/or isolators 18 have the first end affixed to the structural frame 8 and the second end to a top surface 35 of the frame 31. While three scenarios (A, B, C) are shown, those skilled in the art will appreciate that the present disclosure is not limited to three scenarios and may have the structural frame 8 affixed with the plurality of dampers and/or isolators 18 to any part of the motor vehicle 29, without departing from the scope of the present disclosure.

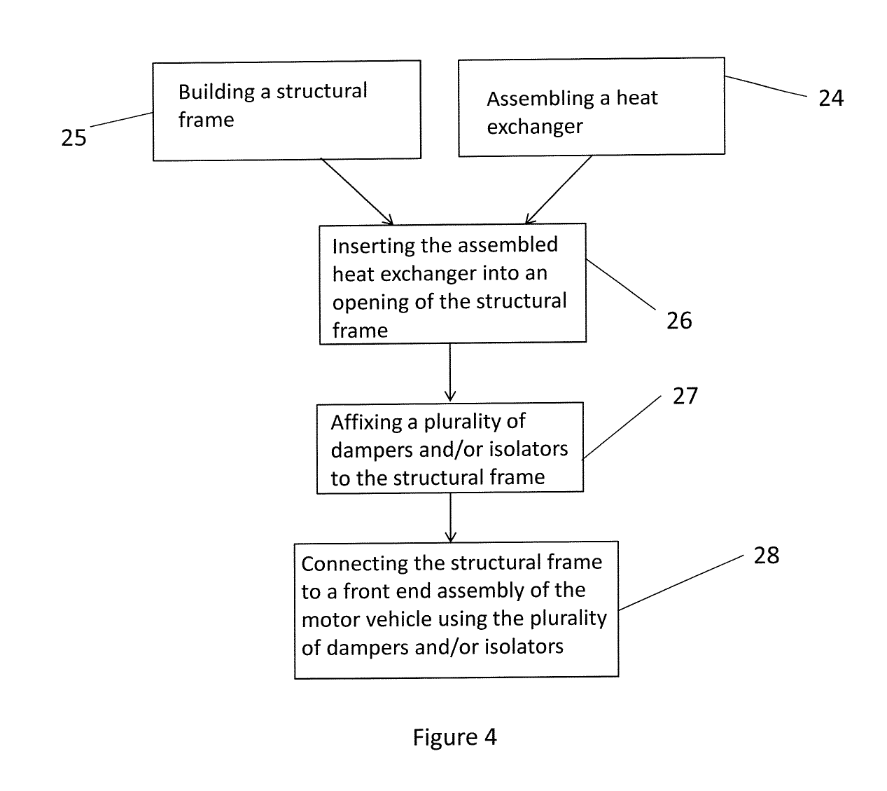

Referring to FIG. 4, a block diagram of using an exchanger frame and core assembly according to one or more embodiments is shown. For purposes of discussion of FIG. 4, the block diagram is a breakdown of how the exchanger frame and core assembly of FIGS. 1-3 are built in the present disclosure. In two initial steps 24, 25, two different methods are done in conjunction or at different times. In one of the initial steps 24, the heat exchanger is assembled. Further at the initial step 24, the heat exchanger includes building a core and at least one tank by affixing the at least one tank on a lateral side of the core. Heat exchangers are well known in the art and it is understand that the heat exchanger of the present disclosures is not limited to the just being built with a core and at least one tank. Further, at the other initial step 25, the structural frame is built. The structural frame is building in a plurality of ways as described above. For example, the structural frame may be made of one selected from a group consisting of a composite material, thermal plastic material, carbon fiber material, glass material, and a metal material. Once the structural frame and heat exchanger are built, the heat exchanger is inserted into the opening of the of the structural frame at a second step 26. One skilled in the art will appreciate how the opening of the structural frame may be on any side of the structural frame. Furthermore, the structural frame isolates at least one the tank with at least one interfacing part of the structural frame.

Additionally, as seen by FIG. 4, in a third step 27, the plurality of dampers and/or isolators is affixed to any surface of the structural frame. While not shown by FIG. 5, the plurality of dampers and/or isolators may be made of one selected from a group consisting of a silicone material and rubber material. While affixing the plurality of dampers and/or isolators to the structural frame is shown as the third step 27, it is not limited to being the third step 27 and may be done during the initial step 25 when the structural frame is built. From the third step 27 (or the second step 26, if the plurality of dampers and/or isolators is affixed to the structural frame during the initial step 25), the structural frame with the heat exchanger within the structural frame is connected to the front end assembly of the motor vehicle using the plurality of dampers and/or isolators at a fourth step 28. It is further envisioned the structural frame may be connect to the front end assembly of the motor vehicle first and then the heat exchanger may be inserted into the structural frame. Additionally, the structural frame is further connected to a bolster of the front end assembly of the motor vehicle and behind an active grille shutter attached to the bolster.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An exchanger assembly, comprising:
a heat exchanger, the heat exchanger comprises a core and at least one tank assembled to the core;
a structural frame, wherein the heat exchanger is removably encapsulated within the structural frame; and
a plurality of dampers and/or isolators affixed to the structural frame, wherein the plurality of dampers and/or isolators facilitate mounting of the structural frame to a motor vehicle front end assembly.

2. The exchanger assembly of claim 1, wherein the structural frame is mounted, via the plurality of dampers and/or isolators, to a bolster of the motor vehicle.

3. The exchanger assembly of claim 2, wherein the structural frame is behind an active grille shutter attached to the bolster.

4. The exchanger assembly of claim 1, wherein the structural frame further comprises an opening through which the heat exchanger is inserted into the structural frame.

5. The exchanger assembly of claim 4, wherein the structural frame completely encloses the heat exchanger.

6. The exchanger assembly of claim 1, wherein the structural frame comprises at least one interfacing part configured to isolate the tank of the heat exchanger.

7. The exchanger assembly of claim 6, wherein the plurality of dampers and/or isolators are affixed to the at least one interfacing part of the structural frame.

8. The exchanger assembly of claim 1, wherein the structural frame is made of one selected from a group consisting of a composite material, thermal plastic material, carbon fiber material, glass material, and a metal material.

9. The exchanger assembly of claim 1, wherein the plurality of dampers and/or isolators is made of one selected from a group consisting of a silicone material and rubber material.

10. The exchanger assembly of claim 9, wherein the plurality of dampers and/or isolators function as an anti-vibration device.

11. The exchanger assembly of claim 1, further comprising:
a first tank assembled on a first lateral side of the core and a second tank assembled on a second lateral side of the core; and
wherein the structural frame comprising a core portion configured to encapsulated the core, a first tank portion configured to encapsulated the first tank, a second tank portion configured to encapsulated the second tank, and wherein the first tank portion and the second tank portion are patterned to be distinct from the motor vehicle.

12. A method for installing an exchanger assembly to a motor vehicle, comprising:
inserting a heat exchanger into a structural frame, wherein the heat exchanger comprises a core and at least one tank assembled to the core, wherein, upon insertion, the core and at least one tank are encapsulate within the structural frame;
affixing a plurality of dampers and/or isolators to the structural frame; and
connecting the structural frame to a front end assembly of the motor vehicle using the plurality of dampers and/or isolators.

13. The method of claim 12, wherein connecting the structural frame to the front end assembly further comprises connecting the structural frame to a bolster of the front end assembly of the motor vehicle.

14. The method of claim 13, wherein connecting the structural frame to the front end assembly further comprises connecting the structural frame behind an active grille shutter attached to the bolster.

15. The method of claim 12, wherein the heat exchanger is inserted through an opening in a top portion of the structural frame.

16. The method of claim 12, further comprising isolating the at least one tank of the heat exchanger with at least one interfacing part of the structural frame.

17. The method of claim 16, further comprising affixing the plurality of dampers and/or isolators to the at least one interfacing part of the structural frame.

18. A method for manufacturing an exchanger assembly, comprising:
assembling a heat exchanger comprising a core and at least one tank by affixing the at least one tank on a lateral side of the core;
building a structural frame to encapsulate the heat exchanger, wherein the structural frame is built with an opening and comprising at least one interfacing part configured to isolate the at least one tank of the heat exchanger;
inserting the heat exchanger into the opening of the structural frame thereby completely encompassing the core and the at least one tank within the structural frame; and
affixing a plurality of dampers and/or isolators to the structural frame.

19. The method of claim 18, wherein the structural frame is made of one selected from a group consisting of a composite material, thermal plastic material, carbon fiber material, glass material, and a metal material.

20. The method of claim 18, wherein the plurality of dampers and/or isolators is made of one selected from a group consisting of a silicone material and rubber material.
